(19) United States
(12) Patent Application Publication
(10) Pub. No.: US 2018/0163546 A1
(43) Pub. Date: Jun. 14, 2018

(54) TURBOMACHINERY ROTOR BLADE

(71) Applicant: NAPIER TURBOCHARGERS LTD, Lincoln, Lincolnshire (GB)

(72) Inventor: Neil Ryan THOMAS, Market Rasen, Lincolnshire (GB)

(21) Appl. No.: 15/580,479

(22) PCT Filed: Jun. 17, 2016
(86) PCT No.: PCT/GB2016/051820

§ 371 Date: Dec. 7, 2017

(30) Foreign Application Priority Data
Jun. 30, 2015 (GB) 1511416.8

(51) Int. Cl. F01D 5/24

(52) U.S. Cl. CPC F01D 5/24; F05D 2220/40

(57) ABSTRACT

A turbomachinery rotor blade is provided having an aerofoil body, and a hole penetrating the aerofoil body from a suction surface to a pressure surface thereof. The hole is suitable to receive a lacing wire. The blade further has a protrusion from the suction or pressure surface. The protrusion extends in a downstream direction from a downstream side of the hole and/or extends in an upstream direction from an upstream side of the hole, thereby disturbing the suction or pressure surface to locally thicken the aerofoil body adjacent the hole. The maximum radial extent of the protrusion in the radially outward direction of the blade is radially coterminous with the outboard side of the hole, and the maximum radial extent of the protrusion in the radially inward direction of the blade is radially coterminous with the inboard side of the hole.

### FIELD OF THE INVENTION

The present invention relates to a turbomachinery rotor blade.

### BACKGROUND

Turbines operating in highly pulsating gas flows may need additional damping/stiffness in order to ensure their survival. This additional damping/stiffness can be provided by inserting a lacing wire through holes in the turbine blades to tie them together and support them during operation.

However, during operation the lacing wire applies an inertial load which produces stresses in the blades. To prevent these stresses from becoming excessive, a boss may be added around the hole in each blade.

The boss is a local thickening of the aerofoil section of the blade, which reduces the stresses produced in the blade by the inertial load of the wire. For example, FIG. 1 shows neighbouring industrial turbocharger turbine blades 1 with a lacing wire 3 inserted through holes 5 in the aerofoil bodies 7 of the blades. A boss 9 surrounds each hole and supports the wire.

Although the boss reduces stresses in the blade, it also disrupts the flow of a gas stream over the aerofoil body and thus reduces the efficiency of the blade.

### SUMMARY OF THE INVENTION

In general terms, the present invention provides a rotor blade with improved aerodynamic performance.

Accordingly, in a first aspect, the present invention provides a turbomachinery rotor blade having an aerofoil body, and a hole penetrating the aerofoil body from a suction surface to a pressure surface thereof, the hole being suitable to receive a lacing wire;
wherein a protrusion from the suction or pressure surface extends in a downstream direction from a downstream side of the hole and/or extends in an upstream direction from an upstream side of the hole, the protrusion disturbing the suction or pressure surface to locally thicken the aerofoil body adjacent the hole, the maximum radial extent of the protrusion in the radially outward direction of the blade being radially coterminous with the outboard side of the hole, and the maximum radial extent of the protrusion in the radially inward direction of the blade being radially coterminous with the inboard side of the hole.

The greatest disruption of the gas stream by the boss of a conventional blade is typically produced by the local thickening inboard and outboard of the hole. In contrast, the thickening downstream of the hole is located in the aerodynamic wake of the wire and therefore has a less adverse effect on the aerodynamics of the aerofoil than the remainder of the boss. Similarly, the thickening upstream of the hole, while not being in the aerodynamic wake, is in a location where the streamlines of the flow approaching the wire either stagnate on the wire or divert around it, and thus also has a less adverse aerodynamic effect. Further, thickening on the suction side of the blade, where air speeds are higher, tends to have a more deleterious effect than thickening on the pressure side of the blade.

It has been found that the inertial loading of the blade by the lacing wire increases the blade stress in locations on the upstream and downstream sides of the hole. However, by including the protrusion downstream and/or upstream of the hole, such stresses can be reduced and the blade need not be thickened inboard or outboard of the hole.

Therefore, in the blade of the present invention, the maximum radial extents of the protrusion do not go beyond the outboard and inboard sides of the hole, i.e. there is no local thickening of the aerofoil body beyond the outboard and inboard sides. Advantageously, disruption of a gas stream flowing over the aerofoil section of the blade may therefore be reduced, improving the efficiency of the blade.

In a second aspect, the present invention provides a rotor having a row of blades according to the first aspect, and further having a lacing wire received in the holes of the blades.

Another aspect of the present invention provides a turbocharger having a rotor of the second aspect.

Further aspects of the present invention respectively provide a gas turbine engine having a rotor of the second aspect, a steam turbine having a rotor of the second aspect and a water turbine having a rotor of the second aspect.

Optional features of the invention will now be set out. These are applicable singly or in any combination with any aspect of the invention.

The protrusion may only extend from the hole in the downstream direction, i.e. not in the upstream direction from the upstream side of the hole. The suction and the pressure surfaces may thus have undisturbed aerofoil surfaces adjacent the upstream side of the hole, i.e. no local thickening of the aerofoil body on the upstream side. In general, a greater (although still small) amount of disruption of the gas stream is produced by a local thickening upstream of the hole than a local thickening downstream of the hole.

For a protrusion which extends from the hole in the downstream direction, the thickening produced by the protrusion may reduce with increasing downstream distance from the hole. Similarly, for a protrusion which extends from the hole in the upstream direction, the thickening produced by the protrusion may reduce with increasing upstream distance from the hole.

The width of the protrusion in the radial direction of the blade may reduce with increasing downstream distance from the hole.

The protrusion may extend in a downstream direction from the downstream side of the hole a distance which is less than four times the diameter of the hole as measured in the radial direction of the blade. Preferably, the protrusion may extend a distance which is less than two times the diameter of the hole as measured in the radial direction of the blade. However, the protrusion may extend a distance which is greater than one quarter of the diameter of the hole as measured in the radial direction of the blade. Preferably, the protrusion may extend a distance which is greater than one half of the diameter of the hole as measured in the radial direction of the blade.

Similarly, the protrusion may extend in an upstream direction from the upstream side of the hole a distance which is less than four times (and preferably less than two times) the diameter of the hole as measured in the radial direction of the blade, and/or which is greater than one quarter (and preferably greater than one half) of the diameter of the hole as measured in the radial direction of the blade.

The maximum height of the protrusion above the adjacent undisturbed aerofoil surface may be less than the half diameter of the hole as measured in the radial direction of the blade. Preferably, the maximum height may be less than one quarter of the diameter of the hole as measured in the radial direction of the blade. However, the maximum height may be greater than one sixteenth of the diameter of the hole as measured in the radial direction of the blade. Preferably, the maximum height may be greater than one eighth of the diameter of the hole as measured in the radial direction of the blade.

The blade may have a protrusion from the suction surface and a protrusion from the pressure surface.

The blade may be a turbine rotor blade or a compressor rotor blade.

### BRIEF DESCRIPTION OF THE DRAWINGS

Embodiments of the invention will now be described by way of example with reference to the accompanying drawings in which:

FIG. 1 shows neighbouring turbine blades with a lacing wire;

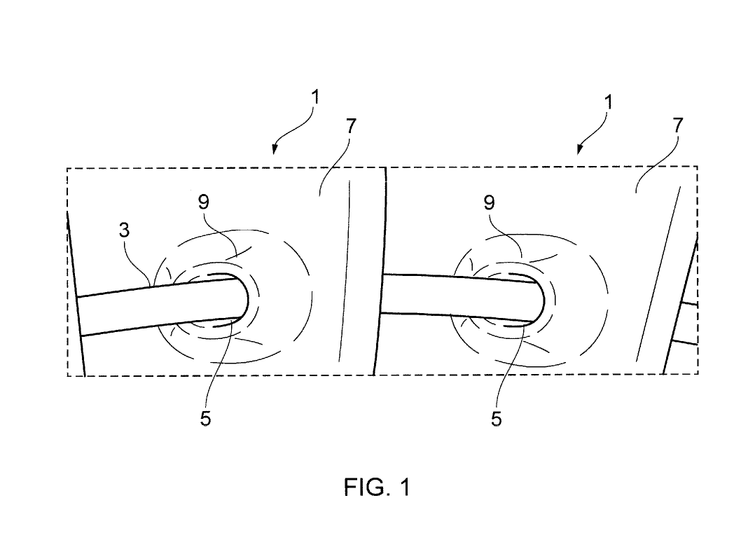

FIG. 2 shows schematically (a) a row of blades viewed from the pressure side and (b) a close-up view of one of the blades viewed from the suction side;

FIG. 3 shows (a) pressure side and (b) suction side calculated strain contours from finite element modelling of a typical lacing wire inertial loading at the hole of the blade of FIG. 2; and

FIG. 4 shows (a) pressure side and (b) suction side calculated strain contours from finite element modelling of a similar lacing wire inertial loading at the hole of a conventional blade with no protrusions.

### DETAILED DESCRIPTION AND FURTHER OPTIONAL FEATURES

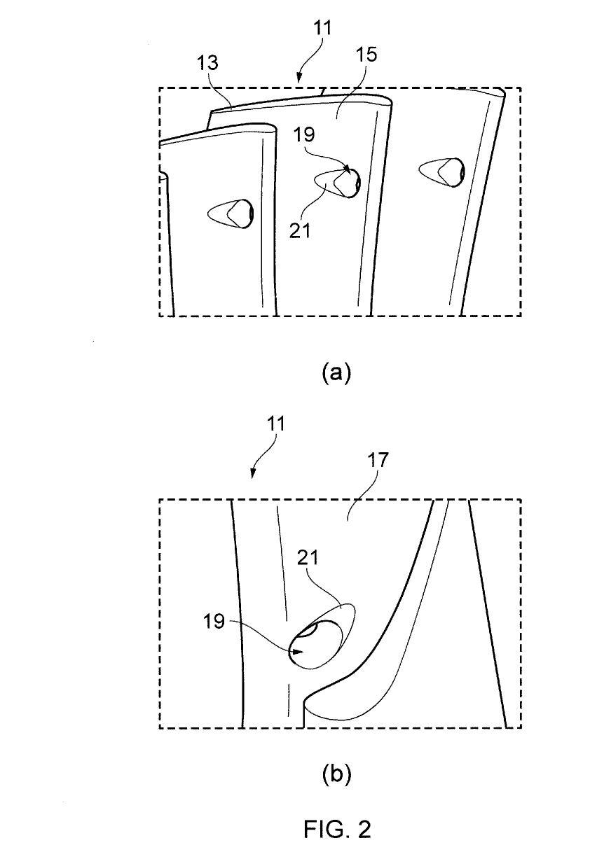

FIG. 2 shows schematically (a) a row of blades for an axial flow turbocharger turbine rotor viewed from the pressure side and (b) a close-up view of one of the blades viewed from the suction side. Each blade 11 has an aerofoil body 13 with a pressure surface 15 and a suction surface 17. A hole 19 penetrates through the aerofoil body from the suction surface to the pressure surface such that a lacing wire can be passed through the hole to link the blade to neighbouring blades.

The blade 11 has a protrusion 21 from the pressure surface 15 and another similar protrusion 21 from the suction surface 17. The protrusions are local thickenings of the aerofoil body and extend in a downstream direction from the downstream side of the hole. Advantageously, these local thickenings increase the contact area between the blade and a wire inserted through the hole 19, reducing the stresses produced in the blade by the inertial load of the wire. Although not shown here, another option is to have a single protrusion from either the pressure or the suction side of the blade.

Each protrusion 21 extends downstream a distance which is less than four times the diameter of the hole 19 as measured in the radial direction of the blade, and more preferably, a distance which is less than two times said diameter. However, each protrusion also extends a distance which is greater than one quarter of said diameter, and preferably greater than one half of said diameter.

Both the width of each protrusion 21 in the radial direction of the blade 11 and the height of each protrusion above the respective surface 15, 17 reduces with increasing downstream distance from the hole 19. The maximum height of each protrusion above the adjacent undisturbed aerofoil surface is less than half the diameter (and preferably less than one quarter of the diameter) of the hole measured in the radial direction of the blade, but greater than one sixteenth (and preferably greater than one eighth) of said diameter.

The pressure 15 and suction 17 surfaces adjacent to the hole 19 have undisturbed aerofoil surfaces in the upstream, inboard and outboard directions, i.e. there is no thickening in an upstream direction from the upstream side of the hole, radially inwards from the inboard side of the hole or radially outwards from the outboard side of the hole. Thus, advantageously, the protrusions 21 reduce the disruption of the gas stream flowing across the aerofoil surface 15, 17 because, in use, they sit in the wake of the lacing wire inserted through the hole 19. In this way, the aerodynamic performance of the blade 11 can be improved.

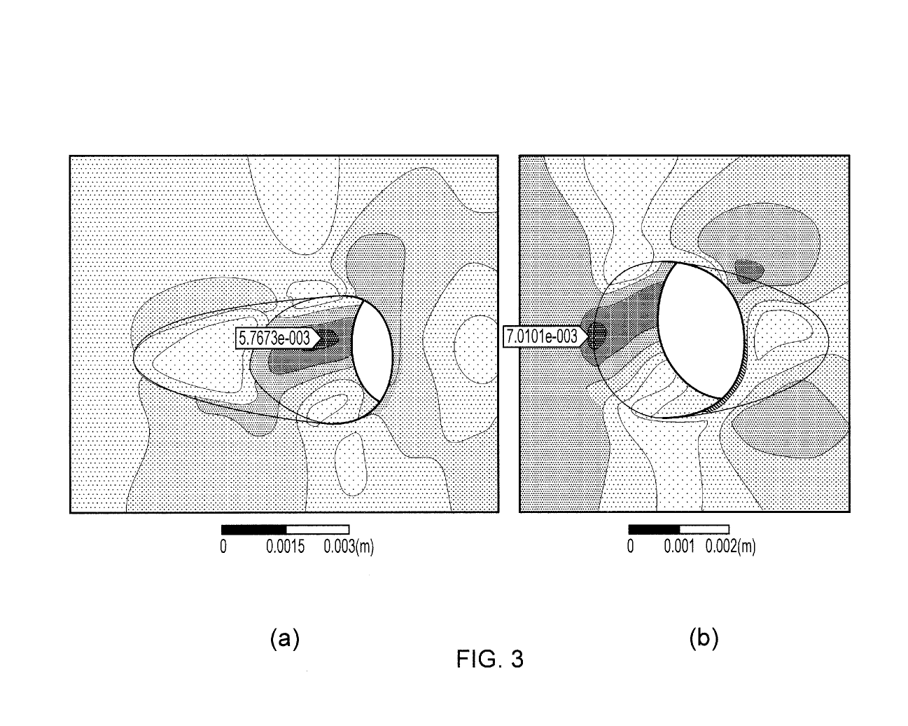

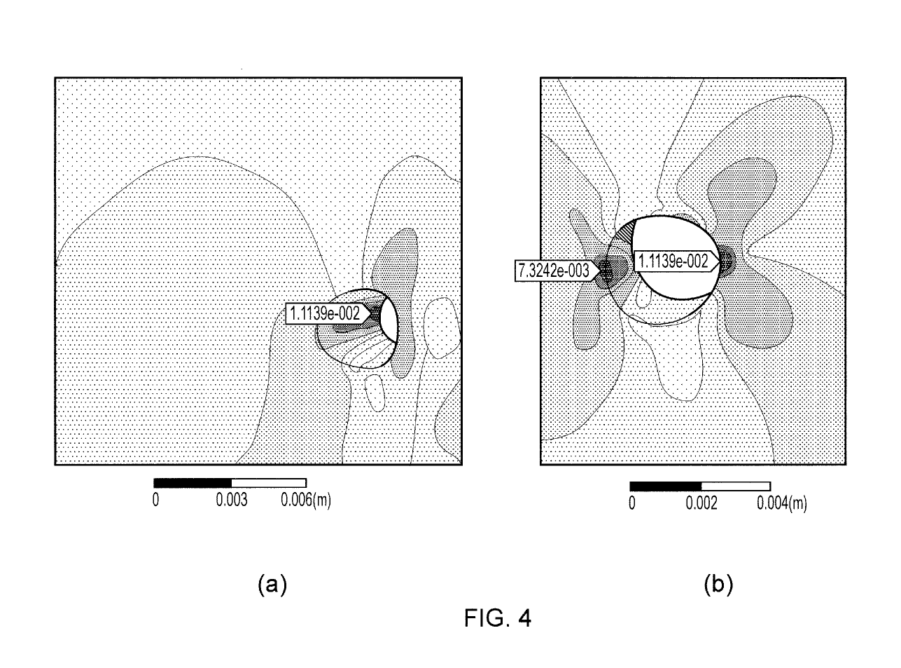

FIG. 3 shows (a) pressure side and (b) suction side calculated strain contours from finite element modelling of a typical lacing wire inertial loading at the hole of the blade of FIG. 2, and for comparison FIG. 4 shows (a) pressure side and (b) suction side calculated strain contours from finite element modelling of a similar lacing wire inertial loading at the hole of a conventional blade with no protrusions. Relative to the blade having no protrusions, at the downstream side of the hole the protrusions 21 are able to usefully alter the pattern of strain experienced by the blade and reduce the maximum strain. Further, the protrusions can displace the point of maximum strain on the downstream side of the hole from a location at the suction side to a less damaging location within the hole. Both these effects can increase the fatigue life of the blade.

While the invention has been described in conjunction with the exemplary embodiments described above, many equivalent modifications and variations will be apparent to those skilled in the art when given this disclosure. For example, although not shown in the drawings, to further increase the fatigue life of the blade, the or each protrusion may also extend in a similar fashion in the upstream direction from the upstream side of the hole. Although upstream of the hole the protrusion is not in the wake of the lacing wire, at this location the streamlines of the flow approaching the wire either stagnate on the wire or divert around it. Indeed, although less preferred, the or each protrusion may extend in the upstream direction instead of the downstream direction. Moreover, the invention is not limited to turbine applications but may be used for other applications. For example, the blade may be used in a low pressure axial flow compressor in a gas turbine engine. Further, the invention is not limited to axial flow devices but may be used in other devices. For example, a rotor blade according to the present invention may be used in a radial or mixed flow device such as a water turbine or a radial flow turbine in a turbocharger. Accordingly, the exemplary embodiments of the invention set forth above are considered to be illustrative and not limiting. Various changes to the described embodiments may be made without departing from the spirit and scope of the invention.

1. A turbomachinery rotor blade having an aerofoil body, and a hole penetrating the aerofoil body from a suction surface to a pressure surface thereof, the hole being suitable to receive a lacing wire;
wherein a protrusion from the suction or pressure surface extends in a downstream direction from a downstream side of the hole and/or extends in an upstream direction from an upstream side of the hole, the protrusion disturbing the suction or pressure surface to locally thicken the aerofoil body adjacent the hole, the maximum radial extent of the protrusion in the radially outward direction of the blade being radially coterminous with the outboard side of the hole, and the maximum radial extent of the protrusion in the radially inward direction of the blade being radially coterminous with the inboard side of the hole.

2. A blade according to claim 1, wherein the protrusion extends from the hole in the downstream direction, and the thickening produced by the protrusion reduces with increasing downstream distance from the hole.

3. A blade according to claim 1, wherein the protrusion extends from the hole in the upstream direction, and the thickening produced by the protrusion reduces with increasing upstream distance from the hole.

4. A blade according to claim 1, wherein the width of the protrusion in the radial direction of the blade reduces with increasing downstream distance from the hole.

5. A blade according to claim 1, wherein the protrusion extends in a downstream direction from the downstream side of the hole a distance which is less than four times the diameter of the hole as measured in the radial direction of the blade.

6. A blade according to claim 1, wherein the protrusion extends in an upstream direction from the upstream side of the hole a distance which is less than four times the diameter of the hole as measured in the radial direction of the blade.

7. A blade according to claim 1, wherein the maximum height of the protrusion above the adjacent undisturbed aerofoil surface is less than half the diameter of the hole as measured in the radial direction of the blade.

8. A blade according to claim 1, wherein the blade has a protrusion from the suction surface and a protrusion from the pressure surface.

9. A blade according to claim 1, wherein the blade is a turbine rotor blade or a compressor rotor blade.

10. A rotor having a row of blades according to claim 1, and further having a lacing wire received in the holes of the blades.

11. A turbocharger having the rotor of claim 10.
